(19) United States
(12) Patent Application Publication
(10) Pub. No.: US 2022/0266627 A1
(43) Pub. Date: Aug. 25, 2022

(54) TRANSFORMABLE WHEEL SUITABLE FOR CROSSING ANY TYPE OF TERRAIN AND AUTONOMOUS ROBOT EQUIPPED WITH AT LEAST ONE SUCH WHEEL

(71) Applicant: BOROBO, Nice (FR)

(72) Inventors: Patrick CHANUDET, Vence (FR); Yevgen DENYSON, Nice (FR)

(73) Assignee: BOROBO, Nice (FR)

(21) Appl. No.: 17/624,603

(22) PCT Filed: Jul. 4, 2020
(86) PCT No.: PCT/EP2020/068916

§ 371 Date: Jan. 4, 2022

(30) Foreign Application Priority Data
Jul. 4, 2019 (FR) FR1907477
Nov. 12, 2019 (FR) FR1912639

(51) Int. Cl. B60B 19/04

(52) U.S. Cl. CPC B60B 19/04; B60B 2900/351; B60B 2900/551; G05D 1/021

(57) ABSTRACT

Wheel having a first part rotable around a central axis, with branches inscribed in a circle whose diameter equals that of the wheel, a circular outer surface of all branches forming a first part of the wheel tread, a second part movable relative to the first part between first closed and second open positions, the second part including branches inscribed in a circle whose center coincides with the central axis, apparatus for moving between first and second positions, the first position where the wheel has a complete circular circumference forming a continuous tread and the second position where the wheel has an incomplete circular circumference forming a discontinuous tread. A third wheel part has teeth whose circular outer surface forms a second part of the wheel tread, the teeth pivotally mounted on the first part, driven by movement of the second part, and movable between two positions.

### TECHNICAL FIELD

The present invention relates to the technical field of autonomous robots and means equipping such robots to facilitate their movement on any type of terrain such as stairs and relates in particular to a transformable wheel suitable for crossing any type of terrain and an autonomous robot equipped with at least one such wheel.

### BACKGROUND ART

Transformable wheels, particularly for wheelchairs, for moving both on flat terrain and crossing obstacles such as stairs, are known.

For example, there are wheels provided with mechanical devices which, by unfolding, form protrusions which allow the wheel to grip on the steps. The outer diameter of the wheel is thus increased, but also the distance between the axis of the wheel and the fulcrum, which has the drawback of requiring a greater driving torque. Such a wheel is, for example, described in document US2011/0127732.

There are also transformable wheels whose outer diameter remains constant regardless of the configuration of the wheel. For example, this is the case with the wheel described in document WO2018/050370. In this document, a wheel system is described comprising two distinct and identical parts in the shape of a cross with a plurality of branches, the two parts being connected to each other by a pivot connection around the axis of the wheel, so as to pivot between two positions:

a first position suitable for movement on flat ground, where the two parts are angularly offset with respect to each other around the central axis so as to form a solid disc in the plane perpendicular to the axis of the wheel,

a second position suitable for movement on stairs where the two distinct parts are angularly offset from each other around the axis of the wheel so that one of the parts completely covers the other.

The two separate parts being identical, they each form a disc of identical diameter, the periphery of which is permanently in contact with the ground and which, when they are in their first position, form an approximately continuous tread.

The disadvantage of this wheel system lies in transitioning from one position to the other one. Indeed, when one of the separate parts shifts with respect to the other, their outer circumference that forms the tread remains permanently in contact with the ground, generating friction. This friction is all the more important and annoying if the load to be carried is important.

### SUMMARY OF THE INVENTION

This is why the aim of the invention is to provide a wheel to allow rolling on any type of terrain and to facilitate the crossing of obstacles such as stair steps and which overcome the aforementioned drawbacks.

Another aim of the invention is to provide an autonomous robot provided with at least one such wheel.

The object of the invention is therefore a wheel comprising:
a first part rotated around a central axis of rotation, provided with a plurality of branches inscribed in a circle of diameter equal to the diameter of the wheel, the circular outer surface of all of these branches forming a first part of the wheel tread,
a second part movable relative to the first part between a first position and a second position, the second part comprising a plurality of branches inscribed in a circle whose center coincides with the axis of rotation,
means for moving from one position to the other one and vice versa, the first position corresponding to a closed position of the wheel in which the wheel has a complete circular circumference forming a continuous circular tread and the second position corresponding to an open position of the wheel in which the wheel does not have a full circular circumference and forms a discontinuous circular tread. According to the main features of the invention, the wheel comprises a third part which is composed of a plurality of teeth, the circular outer surface thereof forming a second portion of the tread of the wheel, wherein the teeth are pivotably mounted on pivot pins of the first part and are driven by the movement of the second part and are movable between two positions.

### BRIEF DESCRIPTION OF THE DRAWINGS

The purposes, objects and characteristics of the invention will become more apparent from the following description when taken in conjunction with the accompanying drawings in which:

FIG. 1 shows a front view of the first part of the wheel according to the invention,

FIG. 2 shows a front view of the second part of the wheel according to the invention,

FIG. 3 shows a perspective view of a tooth of the wheel according to the invention,

FIG. 4a shows a first top view of the inside of the wheel according to the invention in its closed position,

FIG. 4a shows a top view of the inside of the wheel according to the invention in its open position,

FIG. 5a shows a perspective view of the fourth part of the wheel according to the invention,

FIG. 5b shows a top view of the fourth part according to the invention,

FIG. 6a shows a perspective view of the fifth part of the wheel according to the invention in its closed position,

FIG. 6a shows a perspective view of the fifth part of the wheel according to the invention in its open position,

FIG. 7a shows a second top view of the inside of the wheel according to the invention in its open position,

FIG. 8 shows a perspective view of the complete wheel in the closed position,

FIG. 9 shows a perspective view of the complete wheel in the open position,

### DETAILED DESCRIPTION OF THE INVENTION

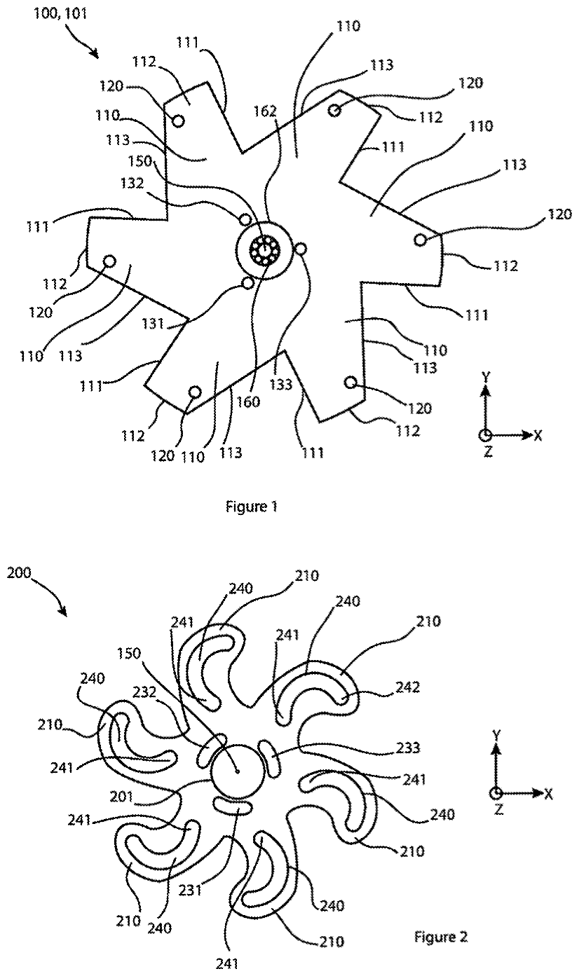

The wheel according to the invention comprises an external part 100 composed of at least one half-shell 101 shown as a front view in FIG. 1 along an XY plane with reference to the reference frame noted in the figure. The part 100, formed by the half-shell 101, is inscribed in a circle defined by its center through which the axis of rotation 150 of the wheel passes, its diameter corresponding to the diameter of the wheel. The central axis of symmetry of the part 100 formed by the half-shell 101 coincides with the axis of rotation 150 of the wheel and is parallel to the Z axis in the figures. The half-shell 101 comprises a plurality of identical branches 110 which are angularly offset with respect to one another in a uniform manner. The number of branches is between three and ten and is preferably equal to six. Each branch 110 comprises a leading edge 111, a trailing edge 113 and a distal edge 112 with respect to the central axis of rotation 150. The outer surface of each branch formed by the distal edge 112 is curved with a radius of curvature corresponding to the radius of curvature of the wheel. Each branch 110 has a pivot pin 120 located near the distal edge 112.

In its central part, the first part 100 formed by the half-shell 101 comprises three bearings 131, 1.32 and 133 equidistant from one another and located at an equal distance from the axis of rotation 150. The half-shell 101 also includes a ball bearing 160 centered on the axis 150 inside a circular recess 162.

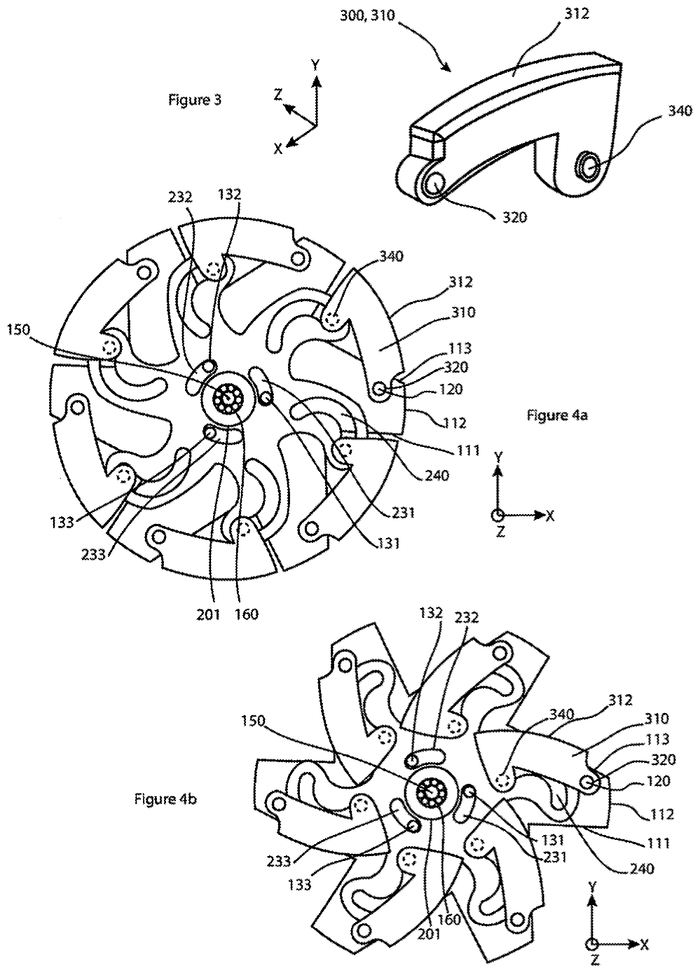

The wheel comprises a second part 200 shown as a top view in FIG. 2. The second part is flat, has a central axis of rotation which coincides with the axis of rotation 150 of the wheel and a plurality of branches 210, the number of which corresponds to the number of branches 110 of the half-shell 101. The part 200 comprises a central through cavity 201 of circular shape, the diameter of which preferably corresponds to the diameter of the recess 160 of the half-shell 101.

In its central part and around the central cavity 201, the part 200 comprises three circular grooves 231, 232 and 233 in the shape of an arc of a circle equidistant from each other and located at an equal distance from the axis of rotation 150. The three grooves 231, 232 and 233 are identical in shape. Each of the three grooves 231, 232 and 233 has an upper edge and a lower edge parallel to the upper edge and located closer to the axis of rotation 150 relative to it and two end edges in the shape of a semicircle. The grooves 231, 232 and 233 are sized so that the bearings 131, 132 and 133 can slide freely in them.

The part 200 also comprises in each of its branches 210 a curved groove 240 of elongated shape and of constant width. Each groove 240 has two ends, a first end located on the side of the axis of rotation 150 and a second end located on the side of the end of the branch 210. The first ends of the grooves 240 are aligned on the circumference of a first circle whose center coincides with the axis of symmetry of the part 200. The second ends of the grooves 240 are aligned with the circumference of a second circle whose center coincides with the axis of symmetry of the part. 200 and whose diameter is greater than that of the first circle. The ends of the grooves located closest to the axis of rotation 150 are called proximal ends and referenced 241 and the ends located furthest from the axis of symmetry are called distal ends and are referenced 242.

The wheel according to the invention also comprises a third part 300 composed of a plurality of teeth 310, the number of which corresponds to the number of branches 110 and 210. Therefore, according to the preferred embodiment of the invention, the wheel has six identical teeth 310, one of which is shown in perspective in FIG. 3. Each tooth 310 has a curved outer surface 312 with a radius of curvature corresponding to the radius of curvature of the wheel. The tooth 310 also comprises a through cavity 320 and a bearing 340 able to rotate freely about its axis which is parallel to the Z axis according to the reference frame shown in the figures.

As can be seen in FIGS. 4a and 4b, the part 200 of the wheel is placed on the first part formed by the half-shell 101 so that the bearings 131, 132 and 133 are inside the three respective grooves 231, 232 and 233. In this position, the axes of symmetry of the half-shell 101 and of the part 200 are aligned with the axis of rotation 150 of the wheel. Part 200 is mobile with respect to part 100. The part 200 can rotate around its axis of rotation between two positions: a first position where the bearings 131, 132 and 133 of the half-shell 101 are blocked on the first end of each of the grooves 213, 232 and 233 in the shape of an arc of a circle, respectively, and a second position where the bearings 131, 132 and 133 of the half-shelf 101 are located against the second end of each of the grooves 231, 232 and 233 in the shape of an arc of a circle, respectively. The grooves 231, 232 and 233 are sized so that the bearings 131, 132 and 133 are pressed against their upper edge in order to better distribute the forces.

The teeth 310 are pivotally mounted on the first part 100 formed by the half-shell 101 and are driven by the movement of the second part 200. Each tooth 310 is located so that its through cavity is crossed by a pivot pin 120 of the half-shell 101 so that each tooth can rotate around the pin 120 to which it is connected. On the other hand, the bearing 340 of each tooth is located inside the groove 240 of the second part 200, the width of the groove 240 being sized so that the bearing 340 can slide from the proximal end 341 of the groove to the distal end 342 and vice versa when the part 200 moves from one position to the other. The bearings 340 of the teeth 310 are shown in dotted lines because they are located on the hidden face of the teeth 310 in FIGS. 4a and 4b. The teeth 310 are movable between two positions.

In the first position of the part 200 shown in FIG. 4a, the bearings 340 of the teeth 310 are located at the distal ends of the grooves 240 of the second part 200. This position corresponds to the closed position of the wheel. In this position, the teeth 310 are arranged so that their outer surface 312 is on the circumference of a circle whose diameter is that of the wheel. In this position, the leading edges of the branches 110 of the half-shell 101 are not visible.

In the second position of the part 200 shown in FIG. 4b, the bearings 340 of the teeth 310 are located at the proximal ends of the grooves 240 of the second part 200. This position corresponds to the open position of the wheel. In this position, the teeth 310 are arranged in a star pattern and their outer surface 312 runs along the trailing edge 113 of the branches 110 of the half-shell 101 so that the leading edges 111 of the branches 110 of the half-shell 101 are visible.

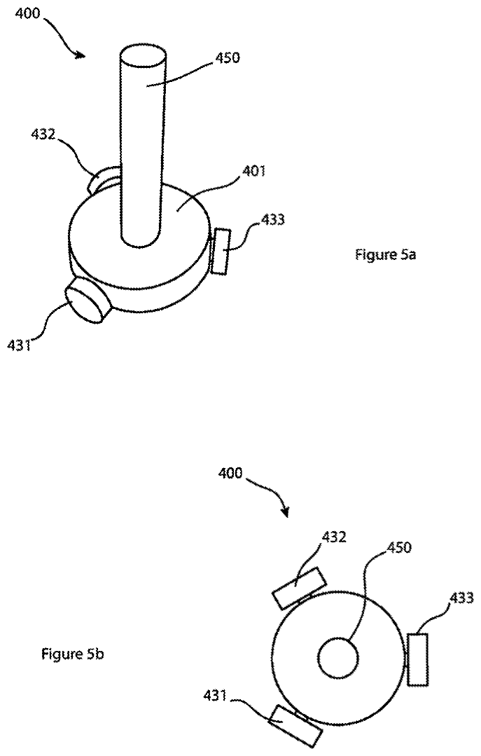

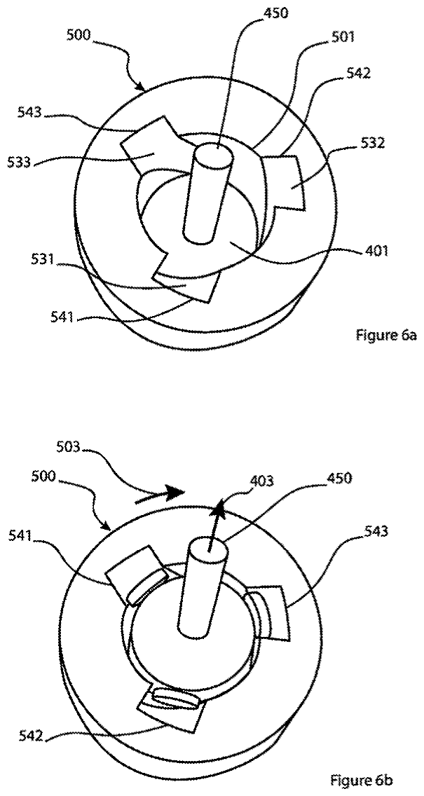

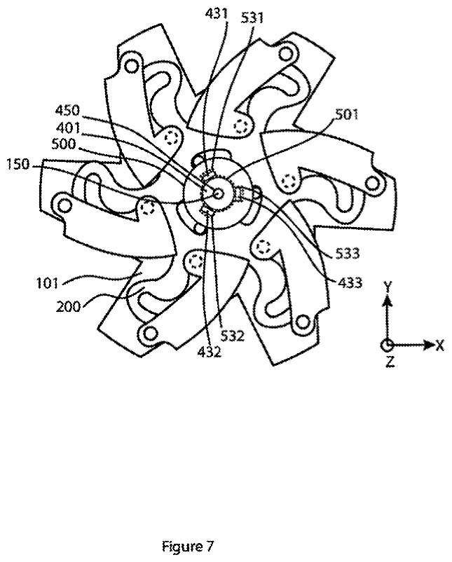

The wheel according to the invention moves from one position to another by mechanical cam and roller means as defined by mechanical parts 400 and 500 and detailed with reference to FIGS. 5a, 5b, 6a and 6b and by drive means external to the wheel.

The sliding part 400 is shown in perspective in FIG. 5a and in top view in FIG. 5b. It mainly comprises a cylinder 401, at least one bearing, and preferably three bearings 431, 432 and 433, and a sliding shaft 450 passing through the axis of symmetry of the cylinder 401. The three bearings are fixed on the side surface of cylinder 401 equidistant from each other and can rotate freely around their axis of rotation. The axes of rotation of the three bearings cross on the axis of symmetry of the cylinder.

The sliding part 400 cooperates with the part 500 and the two parts are shown together in FIGS. 6a and 6b. The part 500 in the form of a hollow cylinder comprises at its center a through cavity 501 in the form of a cylinder whose axis of symmetry coincides with that of the part 500. The part 500 has on its internal wall at least one groove, and preferably three identical helical grooves, located at the same height on the cylinder of the part 500. In this way, the first ends of each groove are equidistant from each other and are angularly offset from each other by an angle of 60 degrees as can be seen in FIGS. 6a and 6b with the visible ends 541, 542 and 543 of the respective grooves 531, 532 and 533. The first end of each groove is located at an angular distance from the second end of between 40 degrees and 60 degrees.

The diameter of the through cavity is sized so that the cylinder 401 can slide freely inside without being hampered on the walls. Bearings 431, 432 and 433 are sized to slide in grooves 531, 532 and 533 from one end to the other and vice versa.

The translational movement along the arrow 403 of the sliding part 400 in the direction of its sliding shaft 450, therefore along the axis 150 of the wheel, drives the part 500 in rotation along the arrow 503. As part 400 moves so that the bearings pass from one end of the grooves to the other end, part 500 rotates on its axis of symmetry by an angle equal to the angular distance between the first ends of the grooves and the second ends of the grooves. The part 500 thus rotates from a first position shown in FIG. 6a to a second position shown in FIG. 6b. The part 500 acts as a rotating cylindrical cam with three helical grooves and the bearings are the rollers which move in the grooves as the sliding shaft 450 moves in translation.

Thanks to fixing means not shown in the figures, the part 500 is fixed to the part 200 in the central part so that their axes of symmetry coincide and are aligned with one another as can be seen in FIG. 7. The axis of symmetry of the part 500 is therefore aligned with the axis of rotation 150 of the wheel. The cylinder 401 is housed in the central cavity 501 of the second part 200. The translation of the sliding part 400 in the direction of the sliding shaft 450 drives the part 500 in rotation around the sliding shaft 450 thanks to the bearings 431, 432 and 433 which slide in the grooves 531, 532 and 533. The part 500 being integral with the part 200, it in turn drives it in rotation around the sliding shaft 450 and therefore around the axis of rotation 150 of the wheel.

The mechanical system for switching from one position to the other has the advantage of not requiring any input of electrical energy on the wheel.

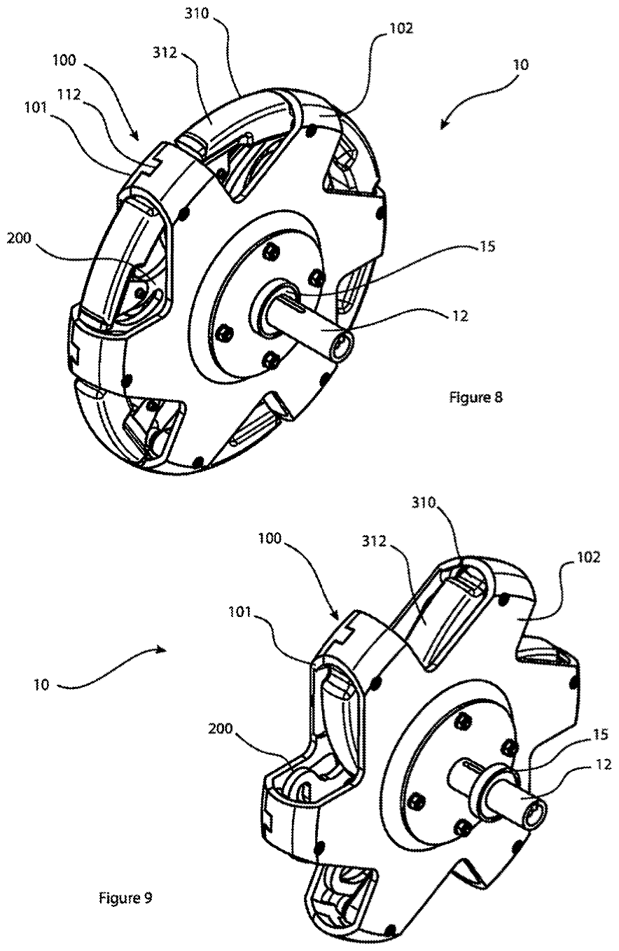

Referring to FIGS. 8 and 9, the wheel 10 is shown complete in perspective. It is composed of the assembly of the external part 100, the movable part 200, the teeth 310, and parts 400 and 500 not visible in the figures. According to a preferred embodiment of the invention, the external part 100 of the wheel also comprises a second half-shell 102 of substantially identical shape to the first half-shell 101 which covers the constituent parts of the wheel by attaching to the distal edges of the half-shell 101. The circular outer surface of the branches of the first part 100 forms a first part of the tread of the wheel. The outer part 100, composed of two half-shells 101 and 102, reinforces the wheel, protects it from dust and affords it a more aesthetic appearance. The wheel 10 is mounted on a shaft 12 provided with a sliding ring 15 sliding between two extreme positions. The ring 15 is connected to the sliding part 400 by its sliding shaft 450 and is integral with this part so that the movement of the ring 15 drives the sliding shaft 450 and the sliding part 400 in motion. The two extreme positions of the ring 15 each correspond to an open or closed position of the wheel. The ring located on the shaft 12 in its position closest to the wheel corresponds to the wheel in the closed position and the ring located on the shaft 12 in its position furthest from the wheel corresponds to the wheel in the open position as it can be seen in FIGS. 8 and 9, respectively.

As can be seen in FIG. 8, which is a perspective view of the complete wheel in the closed position, the part 200 is in its first position. The wheel has a continuous tread formed by the succession of the outer surfaces 312 of the teeth 310 separated by the circular outer surfaces formed along the distal edges 112 of the part 100. The circular outer surface of all of the branches 110 of the first part 100 forms the first part of the tread of the wheel and the outer surface of all of the outer surfaces 312 of the teeth 310 forms the second part of the tread of the wheel. The assembly of the two outer surfaces constitutes the complete circular tread of the wheel in its closed position. In this position, the wheel is perfectly suited to flat terrain. With reference to FIG. 9, which is a perspective view of the complete wheel in the open position, the part 200 is in its second position and the wheel has leading edges substantially perpendicular to the circumferential parts of the tread. In this open position, the wheel does not have a continuous circular circumference and has a discontinuous tread suitable for crossing stairs.

The wheel comprises means for locking the open or closed position of the wheel. At least one wheel as defined according to the invention can equip an autonomous robot. The robot comprises means for detecting the presence of stairs or an obstacle to be crossed, and a control device capable of receiving and processing the signals received from the means for detecting the presence of a staircase to be crossed. These means can be proximity sensors, cameras, etc. The control device controls the transition from the open position to the closed position of the wheel and vice versa. Thus, the control device controls the movement of the sliding ring depending on whether the robot transitions from flat terrain to rough terrain such as stairs and vice versa.

The robot comprises means for maintaining the position of the ring at one or more intermediate positions located between its two extreme positions. These means can be contained in the shaft 12 of the wheel. Thus, according to an alternative embodiment, the wheel can have intermediate positions between the closed position and the open position which correspond to uses on different surface types. For example, a first intermediate position corresponding to an opening of 50% of the teeth 310 adapts the robot to move in soft ground, a second intermediate position corresponding to an opening of 20% of the teeth 310 adapts the robot to move on snow. When an intermediate position is maintained, the bearings 131, 132 and 133 of the first part 100 are located at an intermediate position between the two ends of the grooves 231, 232 and 233.

According to another alternative embodiment of the wheel according to the invention, the robot comprises means for controlling the opening of the teeth depending on the quality of the soil and the speed of travel.

The robot is preferably equipped with two wheels or four wheels as defined in the invention. The wheels are assembled in pairs along a single axis of rotation passing through their center on a single axle or on an axle specific to each wheel.

1. A wheel (10) comprising:
a first part (100) driven in rotation around a central axis of rotation (150), provided with a plurality of branches (110) inscribed in a circle whose diameter is equal to that of the wheel, the circular outer surface of all of the branches forming a first part of the tread of the wheel,
a second part (200) movable relative to the first part between a first position and a second position, said second part comprising a plurality of branches (210) inscribed in a circle whose center coincides with the axis of rotation (150),
means for moving from one position to the other and vice versa, the first position corresponding to a closed position of the wheel in which the wheel has a complete circular circumference forming a continuous tread and the second position corresponding to an open position of the wheel in which the wheel does not have a complete circular circumference and forms a discontinuous tread, further comprising a third part (300) composed of a plurality of teeth (310) whose circular outer surface (312) forms a second part of the tread of the wheel, said teeth being pivotably mounted on pivot pins (120) of the first part, are driven by the movement of the second part and are movable between two positions.

2. The wheel according to claim 1, in which the means for moving from the first position to the second position mainly comprise a mechanical part (500) fixed to the first part (100) and a sliding mechanical part (400) movable in translation in the part (500) in the direction of the axis of rotation (150) of the wheel, the movement of said sliding part (400) driving the rotation of the part (500) which, in turn, drives the rotation of the second part (200).

3. The wheel according to claim 2, in which the mechanical part (500) is in the form of a hollow cylinder and comprises at least one helical groove (531, 532, 533) on its internal wall, the sliding mechanical part (400) comprising at least one bearing (431, 432, 433) able to slide in the groove (531, 532, 533) from one end to the other.

4. The wheel according to claim 1, in which the first part (100) comprises, in its central part, three bearings (131, 132, 133) equidistant from each other and located at equal distances from the axis of rotation (150).

5. The wheel according to claim 1, in which the second part (200) comprises, in its central part, three grooves (231, 232, 233) in the shape of an arc of a circle and equidistant from each other located at an equal distance from the axis of rotation (150), the three grooves (231, 232, 233) being identical in shape.

6. The wheel according to claim 1, in which the second part (200) comprises, in each of its branches, (210) a curved groove (240) of elongated shape and of constant width, each groove (240) comprising a first proximal end (241) located on the side of the axis of rotation (150) and a second distal end (242) on the side of the end of the branch (210).

7. The wheel according to claim 6, wherein each tooth (310) includes a bearing (340) located within the groove (240) of the second part (200), the bearing (340) sliding from the proximal end (341) of the groove to the distal end (342) as the tooth pivots about the pivot pin 120.

8. The wheel according to claim 2, mounted on a shaft (12) provided with a sliding ring (15), sliding between two positions and connected to the sliding part (400) so that the movement of the ring (15) drives the sliding part (400) in motion, the two extreme positions of the ring (15) each corresponding to an open or closed position of the wheel.

9. The wheel according to claim 1, comprising means for maintaining the wheel in at least one intermediate position between the closed position and the open position.

10. An autonomous mobile robot characterized in that it is equipped with at least two wheels according to claim 1, the wheels being assembled two by two along a single axis of rotation passing through their center on a single axle or on an axle specific to each wheel.

11. A mobile robot according to claim 10, comprising means for detecting stair steps or obstacles.
